(19) United States
(12) Patent Application Publication
(10) Pub. No.: US 2007/0006761 A1
(43) Pub. Date: Jan. 11, 2007

(54) Method for producing printing plates

(75) Inventors: Horst Dauer, Rohrbach (DE); Peer Dilling, Friedberg (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG, Offenbach am Main (DE)

(21) Appl. No.: 11/472,212

(22) Filed: Jun. 21, 2006

(30) Foreign Application Priority Data
Jun. 22, 2005 (DE) 10 2005 028 817.0

(51) Int. Cl. B41N 1/00

(52) U.S. Cl. 101/478

(57) ABSTRACT

A method for producing a printing plate, especially inside a printing press, wherein a printing plate with a rewritable surface is provided, and wherein to produce a permanent as well as an erasable image on the surface of the printing plate, the erasing of the surface and/or the imaging of the surface are carried out with the use of an atmospheric plasma.

### BACKGROUND OF THE INVENTION

1. Field of the Invention

The invention concerns a method for producing printing plate having a rewritable surface which is erased and imaged.

2. Description of the Related Art

In printing with a printing plate, basically two types of methods are distinguished: those that operate with a printing plate that can be written once and those that operate with a printing plate that can be rewritten. Printing methods that use rewritable printing plate can also be placed under the heading “computer to press/direct imaging”. The present invention concerns a method for producing a permanent as well as an erasable image on a rewritable printing plate of this type.

AN Roland Druckmaschinen AG markets digital printing presses under the product name of “DICOweb”, which operate with rewritable and erasable printing plate. In the production of printing plate of this type, a printing plate base cylinder is preferably subjected to an erasing step and an imaging step. The imaging of the printing plates is followed by fixing and conditioning of the imaged printing plate. An erasing device that can be used to erase a printing plate of this type is disclosed, for example, in U.S. Pat. No. 6,694,879. U.S. Pat. No. 6,587,134 discloses a device for imaging printing plates of this type. For further information on features of DICOweb technology, see Handbuch der Printmedien [Handbook of Print Media], Helmut Kipphan, Springer-Verlag, 2000, pp. 674-680.

In practice, separately constructed systems or devices for erasing, imaging, fixing, and conditioning are used in digital printing presses that operate with rewritable and erasable printing plates, and this results in a relatively large space requirement for these systems or devices inside the printing press. The greater the number of systems that are used, the greater are the capital costs for a printing press of this type and the greater is the amount of time that is necessary to retrofit the printing press. To reduce the number of systems and devices needed to produce printing plates of this type and thus to reduce the space requirement, the capital costs, and the retrofitting times, U.S. Pat. No. 6,424,366 discloses that a laser source used for imaging also be used for fixing the imaged printing plate. This patent also discloses erasing an imaged printing plate by means of the laser source. The laser source is operated at different intensity levels for each of these purposes. Accordingly, it is already known that a laser source used for imaging can also be used for fixing and erasing an imaged printing plate.

### SUMMARY OF THE INVENTION

Proceeding from this prior art, the objective of the invention is to create a novel method for producing printing plates. In accordance with the invention, an atmospheric plasma is used to carry out at least the erasing of the surface immediately before the imaging of the surface and/or to carry out preparation of the surface a certain amount of time after the erasing.

Therefore, in accordance with the present invention, the erasing of the surface of an imaged printing plate is carried out with the use of an atmospheric plasma. With the use of an atmospheric plasma, impurities on the printing plate or images to be erased can be effectively removed from the surface of a printing plate that is to be erased. In the ideal case, if the imaging immediately follows the erasing without a time delay, i.e., without a timing element, it is possible to dispense with preparation of the printing plate for imaging. If there is a so-called timing element, i.e., a time delay, between the erasing and the imaging, to prepare for the imaging of a printing plate, the printing plate is subjected to a plasma treatment with atmospheric plasma immediately before the actual imaging, which makes it possible to increase the adherence to the printing plate of the imaging material that is subsequently to be applied by means of a thermal transfer process. By subjecting the printing plate to be imaged to a plasma treatment before the actual imaging, it is possible to dispense with a separate fixing process and possibly a process for rendering the printing plate hydrophilic.

The production of a permanent and erasable image on a rewritable printing plate then ideally comprises only the steps of erasing and imaging, while the steps of fixing and rendering hydrophilic by the plasma treatment become unnecessary. This drastically reduces the number of systems or devices needed to produce the rewritable and erasable printing plates. This in turn results in a reduction of the space requirement, a reduction of the capital costs, and a reduction of the time required for retrofitting work. Further advantages of the method of the invention are a clean surface, improved adherence, and proper surface tension to help create the proper hydrophilic state.

Furthermore, under certain boundary conditions, various variants of the method of the invention are possible:

Ideally, without a time delay in the sequence of the individual process steps, i.e., without timing elements between the individual steps, the method includes only the steps of erasing, imaging, and printing.

However, if there is a timing element, i.e., a time delay, of about 15 to 30 minutes between the erasing and the imaging, the surface to be imaged is subjected to a treatment with atmospheric plasma immediately before the actual imaging of the surface by a thermal transfer process. This step constitutes a preparatory step for the imaging of the surface. The method thus includes the steps of erasing, a timing element (15 to 30 minutes), preparation, imaging, and printing.

In addition, it is already customary in printing technology to rubber-coat the surfaces of printing plates to protect the surfaces from contamination or damage by atmospheric oxygen. A rubber-coating medium is intended to preserve and maintain the printing differentiation with respect to the ink and/or water flow. For example, the older application DE 10 2004 047 456 discloses a method and a device for rubber-coating a printing plate.

The inclusion of the rubber-coating step in the method of the invention in turn allows a timing element between the imaging and the printing, so that the method comprises the steps of erasing, imaging, rubber-coating, a timing element (15 to 30 minutes), and printing.

Furthermore, the method of the invention with the inclusion of the possible timing elements can be represented especially as follows: erasing, a timing element, preparation, imaging, rubber-coating, a timing element, and printing.

Naturally, an additional fixing after the imaging or after the rubber-coating is also possible:

Variant A: erasing, imaging, fixing, printing.

Variant B: erasing, a timing element, preparation, imaging, fixing, printing.

Variant C: erasing, imaging, rubber-coating, fixing, a timing element, printing.

Variant D: erasing, a timing element, preparation, imaging, rubber-coating, fixing, a timing element, printing.

In accordance with a preferred refinement of the invention, the atmospheric plasma for erasing the surface, or fixing it, or preparing it, especially rendering it hydrophilic, acts with different power densities on the surface to be erased or imaged.

This offers the possibility, in an especially advantageous way, of carrying out the various steps of the method of the invention, such as erasing, preparation, or fixing, in sequence with a single device for the plasma treatment of the surface of the printing plate. In other words, erasing is preferably carried out using a high power density, fixing is preferably carried out using an intermediate power density, and preparation, especially rendering the surface hydrophilic, is preferably carried out using a low power density.

### DETAILED DESCRIPTION OF THE PRESENTLY PREFERRED EMBODIMENTS

Preferred refinements of the invention are described in the description which follows. A specific embodiment of the invention is explained in greater detail below, but the invention is by no means limited to this embodiment.

The present invention concerns a method for producing a printing plate, namely, for producing a permanent as well as an erasable image on the surface of a rewritable and erasable printing plate. This method is preferably carried out inside a printing press. To produce a printing plate of this type, a printing plate or a printing plate base cylinder is provided with a rewritable and erasable surface. The surface is first erased and then imaged.

In accordance with the present invention, the erasing of the surface is carried out by a plasma treatment that involves the use of an atmospheric plasma. When an atmospheric plasma acts with a relatively high power density on the surface to be erased, an image to be erased is removed from the surface along with any contaminants. The atmospheric plasma for erasing the surface is produced by a plasma generator, which has at least two electrodes positioned a certain distance from the surface of the printing plate, between which an electric arc is formed. This results in the formation of large numbers of positive and negative charge carriers, which are conveyed by compressed air to the surface to be erased. At a suitably high power density of the atmospheric plasma, the surface of a printing plate can be effectively cleaned and erased in this way.

In accordance with the present invention, to prepare for the imaging of the surface of the printing plate, the surface of the printing plate is subjected to a plasma treatment with atmospheric plasma immediately before the actual imaging of the surface, so that immediately after the plasma treatment, the surface can be imaged by means of the thermal transfer process, which is already well known from the prior art. Between the plasma treatment with the atmospheric plasma for erasing the surface to be imaged and the actual imaging of the surface by the thermal transfer process, there may then be a time interval of up to 30 minutes and preferably a maximum of 15 minutes, i.e., a timing element.

The atmospheric plasma in turn is formed by an electric arc between at least two electrodes of the plasma generator, which are positioned a certain distance from the surface to be imaged. The power density of the plasma treatment or of the atmospheric plasma during the preparation and fixing is preferably lower than the power density of the plasma treatment or the atmospheric plasma during the erasing of the printing plate. In the present case, the power density for the fixing is preferably greater than the power density for the preparation.

The plasma treatment immediately before the imaging of the printing plate can improve the adherence of the imaging material to be applied by the thermal transfer process to the extent that it becomes possible to dispense with the fixing step that follows the imaging in the prior-art methods. Moreover, the surface of the printing plate, which usually consists of a metal, is affected by the plasma treatment in such a way that the printing plate has good fountain solution wetting properties in the sections in which imaging material is not applied, so that it is also possible to dispense with the step in which the surface is rendered hydrophilic in the prior-art methods. Accordingly, a press-ready printing plate is available immediately after the imaging, so that the printing can begin immediately after the imaging. The steps of fixing and rendering hydrophilic are thus made unnecessary by the plasma treatment.

As has already been mentioned, for erasing the printing plate and for preparing it or for fixing, the atmospheric plasma acts with different power densities on the surface to be erased or imaged. The plasma has a higher power density during the erasing of the surface than during preparation for imaging. The different power densities can be adjusted by operating the plasma generator with different intensities. It is also possible to adjust the distance of the plasma generator from the surface of the printing plate. Then, if the printing plate is produced inside a printing press, the plasma generator is positioned together with an imaging system on a crossbeam and is translated relative to the printing plate while the printing plate cylinder rotates. In this case, the power density can also be adjusted by adjusting the speed of the translational relative motion of the plasma generator relative to the rotating printing plate and/or by adjusting the rotational speed of the printing plate.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for preparing a printing plate inside a printing press, said printing plate having a rewritable surface which is imaged, said method comprising:
erasing the surface using an atmospheric plasma; and
imaging the surface.

2. The method of claim 1 wherein the surface is imaged within thirty minutes after erasing.

3. The method of claim 2 wherein the surface is imaged within fifteen minutes after erasing.

4. The method of claim 1 further comprising:
preparing the surface using an atmospheric plasma, after erasing and prior to imaging.

5. The method of claim 4 wherein a time interval of at least fifteen minutes elapses between erasing and preparing.

6. The method of claim 1 wherein said imaging is done by a thermal transfer process, said method further comprising:
rubber coating said surface after imaging.

7. The method of claim 3 further comprising:
rubber coating said surface after imaging; and
allowing a time interval of at least fifteen minutes between rubber coating and printing.

8. The method of claim 7 further comprising:
fixing the surface after rubber coating; and
allowing a time interval of at least fifteen minutes between fixing and printing.

9. The method of claim 2 further comprising allowing a maximum of thirty minutes to elapse between imaging and printing.

10. The method of claim 2 further comprising:
rubber coating said surface after imaging; and
allowing a maximum of thirty minutes to elapse between rubber coating and printing.

11. The method of claim 1 further comprising:
placing at least two electrodes in proximity to the surface; and
producing said atmospheric plasma with an arc between said at least two electrodes.

12. The method of claim 1 1 further comprising conveying said atmospheric plasma toward said surface using compressed air.

13. The method of claim 4 wherein said erasing is performed with an atmospheric plasma at a higher power density than the surface preparation.

14. The method of claim 13 further comprising fixing the surface after imaging, said fixing being performed with an atmospheric plasma at a power density intermediate the power densities used for erasing and surface preparation.

15. The method of claim 13 wherein said atmospheric plasma is produced by a plasma generator at a distance from said surface, said power density being varied by varying said distance.

16. The method of claim 13 wherein the atmospheric plasma is produced by a plasma generator at a distance from said surface, said power density being varied by at least one of translating said generator relative to said surface and rotating said surface.
